(19) United States
(12) Patent Application Publication
(10) Pub. No.: US 2012/0062503 A1
(43) Pub. Date: Mar. 15, 2012

(54) DEVICE FOR INTEGRATING CAPACTIVE TOUCH WITH ELECTROPHORETIC DISPLAYS

(75) Inventors: Zhiming Zhuang, Kildeer, IL (US); William P. Alberth, Prairie Grove, IL (US); Ken K. Foo, Gurnee, IL (US)

(73) Assignee: MOTOROLA-MOBILITY, INC., Libertyville, IL (US)

(21) Appl. No.: 12/881,267

(22) Filed: Sep. 14, 2010

(51) Int. Cl. G06F 3/045

(52) U.S. Cl. 345/174

(57) ABSTRACT

A display assembly comprises a touch sensor including at least one first electrode and at least one second electrode, and an electrophoretic display (EPD). The EPD including the at least one first electrode as a drive electrode.

### BACKGROUND

Electrophoretic displays (EPDs) have become very popular in always on display applications like electronic books (E-books), watches, and other consumer goods, in part due to the high reflectance and lower power consumption associated with this display technology. Due to their highly reflective nature, EPD displays rely on ambient light for illumination.

Many consumers have become accustomed to touch panels in their everyday life, for example in electronic appliances such as mobile phones, tablet PCs, automatic teller machines, kiosks such as those found at malls or airports, navigation devices, and many other applications. As a consequence, effort has been directed toward integrating a touch panel with an EPD to provide a user interface with touch functionality.

Conventional integration of the touch panel with an EPD has typically yielded a device with no backlight and a monochromatic display. As seen in FIG. 1, which illustrates a conventional integration of a touch panel with an EPD, light has to pass through the touch panel twice for the reflection to be seen by a user. Since typical touch panes (whether they are capacitive or resistive) have transmittance around 80-90%, light loss is 20-40% for a reflectance from an EPD that is coupled to a touch panel. Should a designer use color EPDs, the amount of light loss is particularly problematic, because a color EPD will likely use a color filter, which further increases light loss, and makes the EPD only marginally readable in some ambient light environments. As a consequence, the usability of a product that incorporates a color EPD and touch panel has heretofore been undesirably limited.

One solution proposed by industry designers includes using an anti-reflective coating to reduce glare and improve transmittance. However, anti-reflecting coatings are expensive to apply in mass quantities. Another solution has involved lamination of touch panels in the manufacturing process. However, lamination is difficult to implement effectively due to manufacturing defects such as air bubbles that are created on the display. Additionally, as the display size increases, the cost of lamination grows economically unacceptable for most products.

Other industry designers have decided to avoid integrating an EPD with a touch panel. Instead, a transmissive system is used that includes a backlight to increase the amount of light emitted from the display without relying exclusively on reflectance. However, this can detrimentally impact battery life, and even where battery life is not a concern, reflections produce “noise” that interferes with the user's enjoyment of the device.

Therefore, an improved touch panel and EPD integration is needed.

### BRIEF DESCRIPTION OF DRAWINGS

FIG. 1 illustrates a schematic of light loss for a prior art EPD with a touch panel;

FIG. 2A illustrates an exemplary waveform diagram for capacitive touch and an EPD;

FIG. 2B illustrates exemplary timing and voltage for an EPD as seen in FIG. 2A;

FIG. 2C illustrates exemplary timing and voltage for a capacitive touch panel as seen in FIG. 2A;

FIG. 3 illustrates an exemplary capacitive sensing circuit;

FIG. 4 illustrates an exemplary schematic;

FIG. 5 illustrates a second exemplary capacitive sensing circuit;

FIG. 6 illustrates an exemplary schematic;

FIG. 7 illustrates a conventional timing diagram showing top plane voltage, segment voltage, and optical state of an electrophoretic display;

FIG. 8 illustrates a conventional capacitive sensor circuit design;

FIG. 9 illustrates an exemplary mobile device with a touch panel integrated with an EPD;

FIG. 10 illustrates an exemplary schematic of a side view; and

FIG. 11 illustrates an exemplary schematic of a side view.

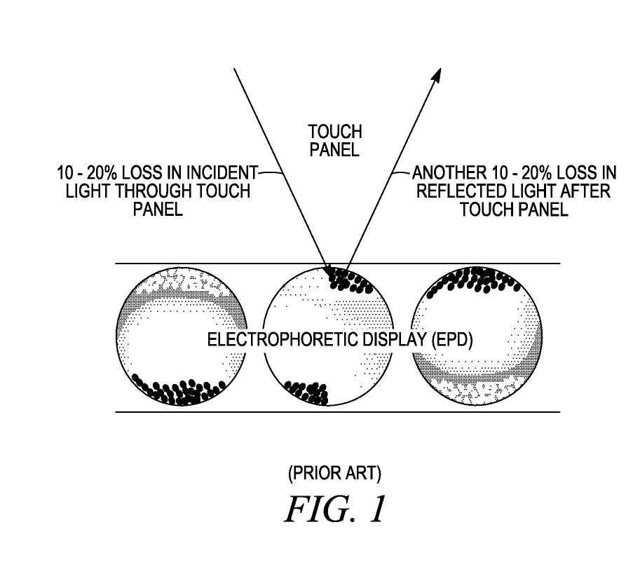

### DETAILED DESCRIPTION

A display assembly comprises a touch sensor including at least one first electrode and at least one second electrode, along with an electrophoretic display (EPD). The EPD including the at least one first electrode as a drive electrode.

One embodiment of the present invention describes an electronic device that includes a capacitive touch sensor having at least first and second spaced sensors, and an electrophoretic display (EPD). The EPD includes at least one of the first and second spaced sensors of the capacitive touch sensor as its drive electrode. The EPD is positioned between the at least first and second sensors and a display substrate.

Another embodiment employs a method for integrating capacitive touch capability with an electrophoretic display (EPD) that includes employing at least one electrode of the EPD as the EPD's driving electrode and also as a capacitive touch sensor electrode.

Another embodiment includes an electronic device having a patterned top plane electrode disposed as a planar capacitive sensor electrode; and a bottom plane electrode disposed as a planar capacitive sensor electrode. An electro-optical layer lies between the top and bottom plane electrodes, and includes a dispersion medium and electrophoretic particles, both of which are influenced by an electrostatic field. The electrophoretic particles are enabled to migrate within the dispersion medium. Lastly, a controller circuit generates driving signals applied to the top plane electrodes for touch sensing and driving the electro-optical layer.

As used herein, an electrophoretic display refers to an electronic visual display that produces visible images for viewing by an observer by controlling pigment particles using an applied electric field. Such displays may take the form of active matrix displays. Electrophoretic displays can be implemented using an array of controlled pixels or controlled segments to generate images.

As used herein, an image may include either two-dimensional or three-dimensional pictorial representations of information, for example, text, icons, avatars, digitized photographs (still or moving, thumbnail-sized or full-sized). This list is not exhaustive, but is meant to be illustrative to those skilled in the art. The representative information may include spreadsheets, news, cinema, sports, entertainment, and gaming information, for example.

As used herein, an electrode can refer to an electrical conductor that is used to make an electrical/magnetic connection, detect contact or create an electrical effect. Touch sensor electrodes are contiguous areas defining a contact area, and may, for example, comprise an electrically conductive material applied to an area of a substrate, the material defining a sensor point for finger proximity or contact. A drive electrode refers to an electrical conductor at which a drive voltage is applied to a display panel to produce a desired visual effect.

As used herein a touchscreen refers to an electronic visual display that can detect the presence and location of a “touch” to the display area. A touch can include direct physical contact with the display or a physical object in close enough proximity to the surface of the display area that it produces an effect that can be detected by a touch sensor. The touchscreen can employ a touch panel and a display panel. The touchscreen can employ haptic or vibratory feedback and/or audio. For example, conventional resistive touchscreens employ a resistive touchscreen panel overlying a display panel that generates an image viewed by a user. The resistive touchscreen panel is controlled to produce an electrical current registered as a touch, and the value of the resulting electrical current produced in response to the perceived touch is used by a controller to determine the point of contact.

According to another example, a capacitive touchscreen may employ a capacitive touchscreen panel overlying a display panel that generates an image viewed by a user. The capacitive touch screen panel can, for example, employ an electrical conductive layer, such as a highly transparent conductor (for example, indium tin oxide (ITO) or another well known transparent conductor), applied to an insulator using any known suitable technique. The insulator may be any suitable transparent material, such as glass or other dielectric, as is well known.

In a mutual capacitance system, an object such as a finger or stylus alters the mutual coupling between row and column electrodes, which are sequentially scanned. In absolute capacitance systems, the object, such as a user's finger loads a sensor, (wherein the user's finger is grounded to earth via the user's body), and increases the parasitic capacitance to ground. In such capacitors, a controller determines the relative location of the object proximate to the display panel from the electrical value representing the variation in capacitance.

As used herein, a capacitive touch panel refers to a control circuit and one or more touch sensors that are used to detect either direct or proximate positioning on a touchscreen. The control circuit, as is well known, can be implemented using any suitable known commercially available circuit, such as those available from Atmel or Analog Devices. The control circuit, for example, includes an excitation source, such as a high frequency signal source, which may, for example, be in the frequency range of approximately 200 kilohertz to 300 kilohertz; a detector; a suitable analog-to-digital converter; and at least one microprocessor. The control circuit or controller can include processors for generating drive signals. A touch sensor may include a transmitter and receiver. The transmitter can include a first touch sensor electrode connected to the excitation source. The first touch sensor electrode can be formed by any well-known means of making a conductor. For example, an electrically conductive trace may be applied to a surface of a substrate, or an electrically conductive coating, or the like. The receiver may include a second touch sensor electrode connected to the detector. The second electrically conductive electrode can be formed by any suitable electrical conductor, such as an electrically conductive coating, an electrically conductive plate, a trace material applied to a substrate, or the like. The sensor transmitter and receiver are spaced by a dielectric material.

As used herein, a display is an output device for presentation of information via visual, tactile, or auditory cues and may include a transparent surface, such as glass or plastic, and may be rigid or flexible. The display may be reflective, transflective, or include an anti-reflective coating. Examples of displays include organic and inorganic light emitting electrodes, active-matrix organic light emitting electrodes, plasma, laser, or liquid crystal diodes. Displays may be affixed to electronic devices such as mobile phones, tablets, panels, e-books, pads, gaming devices, kiosks, television sets, billboards, or computer monitors, for example. The display may be either active or passive in its ability to either generate or modulate light. The display includes small picture elements or pixels arranged in multiple configurations such as dot matrix, and a plurality of segments. Any physical gap between individual pixels or groups of pixels may be considered a pixel gap.

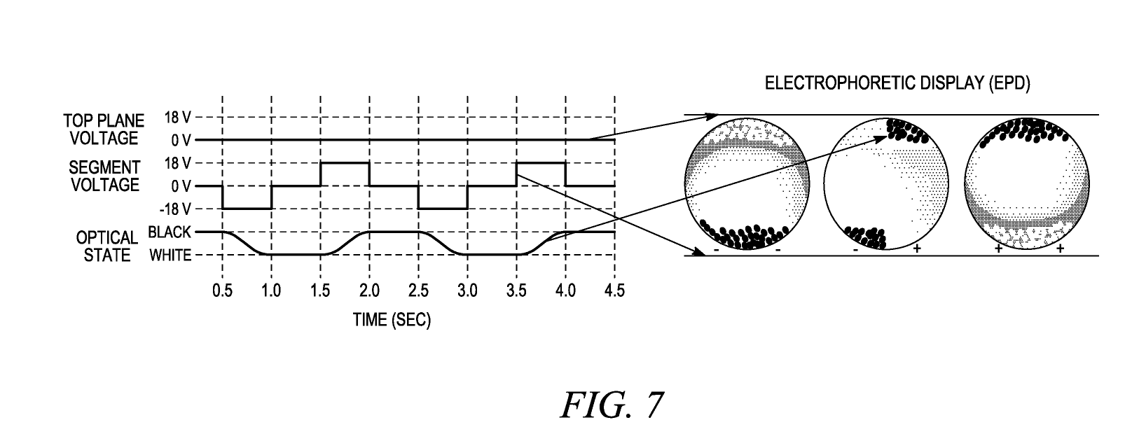

EPD displays are driven by high threshold voltages (see FIG. 7), typically greater than 10V (Vₜₕ>10V) and low frequencies, typically less than 10 Hz (Fₜₕ<10 Hz) to generate an optical response. One methodology for driving the EPD is termed tri-level driving, wherein the top plane (V_{com}) is held to a constant voltage (i.e., ground voltage).

The optical response of EPD is proportional to the voltage applied times the pulse width, thereby effective voltage or V_{eff}=Vₛ*Tₚ, where Vₛ=switching voltage and Tₚ=pulse width of Vₛ.

Accordingly, a typical switching voltage of Vₛ=+/−(15-18V) and Tₚ>100 ms are needed to generate any noticeable optical change in EPD. Therefore, tri-level driving requires drivers capable of simultaneous +15 v, 0V, and −15V operation. In addition, the top plane is held at 0V or V_{com} and an appropriate electric field is applied across each pixel.

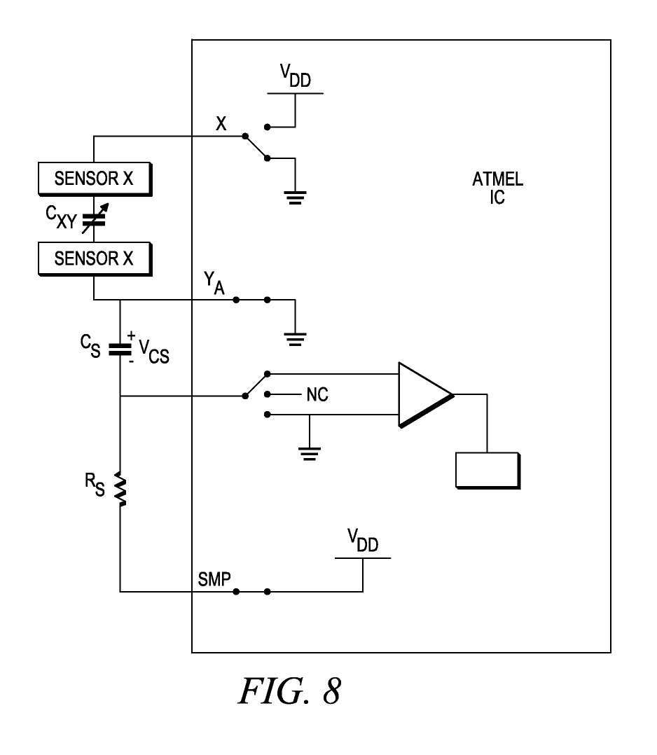

In the capacitive touch plane industry, also referred to as a capacitive sensor herein, the excitation voltage (see FIG. 8), V_{DD} in sensor electrode X is fairly low (1.8-2.8V), at very high frequencies (typically, about 50-250 KHz) with a burst time T_{b}˜1 ms or less (−100 charging pulses) over a 12-16 ms frame time, T_{f}.

The maximum cumulated voltage on the sensor electrode Y, V_{cs} is even smaller. Typically at ˜100 mV over ˜ 1/10^{th} the frame time for a typical sensor resolution. If one applies the aforementioned voltage, either V_{DD} or V_{cs} to the V_{com} of an EPD display, it would not generate hardly any noticeable optical response, because V_{DD}*T_{b} or V_{cs}*T_{f} are well below Vₜₕ*Tₚ. Furthermore, the frequency of capacitive touch excitation voltage is much greater than the frequency of the EPD excitation voltage, Fₜₕ, and is far beyond the capability of the EPD response time and it also shouldn't generate a noticeable optical response.

Alternatively, the low frequency of the EPD driving voltage (<10 Hz) can be viewed as a DC signal, if coupled to sensor electrode Y; and it can be filtered out by a firmware algorithm in a capacitive sensor controller. The capacitive sensor controller controls image generation on the display and is responsive to a user's touch contacts on the associated touch sensor.

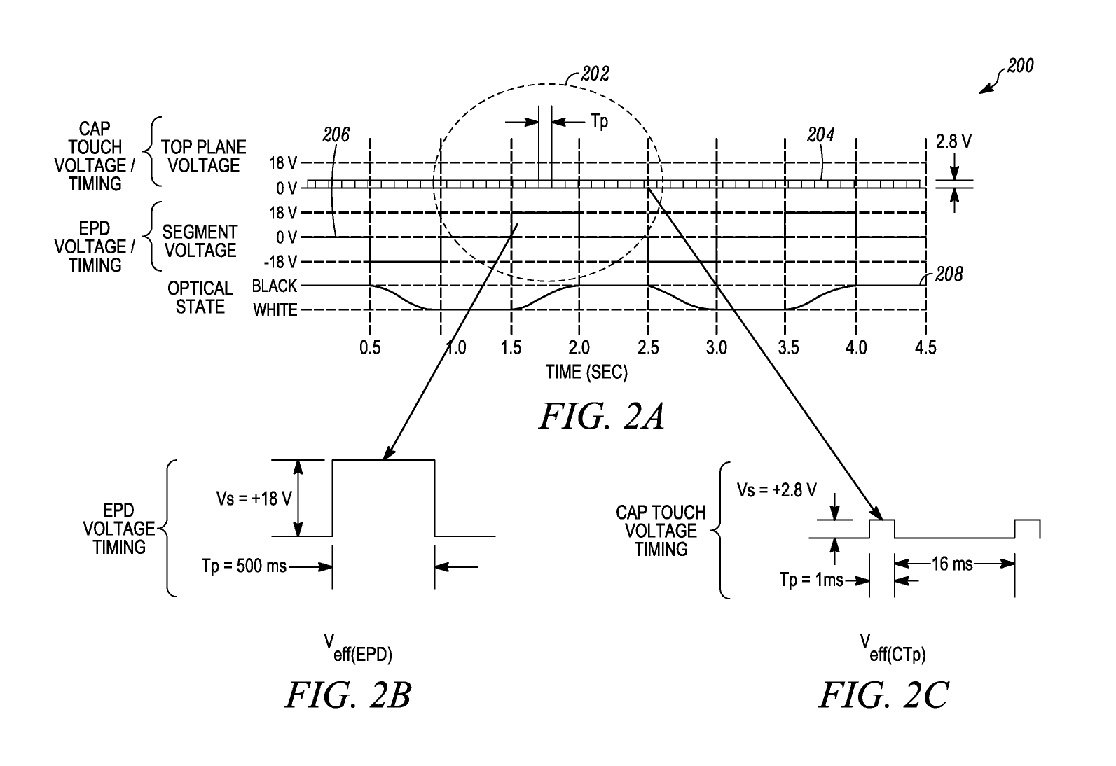

Referring to FIG. 2A, waveform diagram 200 shows an eyelet 202 illustrating a segment of the waveform diagram 200. Eyelet 202 shows a segment of top plane voltage 204 and a segment of EPD voltage 206. Waveform diagram 200 includes a bottom waveform 208 showing optical states of the EPD.

FIG. 2B illustrates exemplary timing, Tₚ and voltage, Vₛ of EPD on the EPD segment seen in eyelet 202 of FIG. 2A. The exemplary effective voltage of the EPD, V_{eff(EPD)} is 9V. The segment voltage is +18V and the period is 500 ms.

FIG. 2C illustrates exemplary timing, Tₚ and voltage, Vₛ of the capacitive touch panel on an EPD top plane. The exemplary effective voltage of the capacitive touch on the EPD top plane, V_{eff(CTP)} is 0.0028V. The top plane voltage is +2.8V and the period is 1 ms with a delay of 16 ms between pulses.

The effective voltage of the EPD (shown in FIG. 2B) is substantially greater than the effective voltage of the capacitive touch on the EPD top plane (shown in FIG. 2C).

One embodiment of the present invention uses a top plane electrode as a planar capacitive sensor pattern.

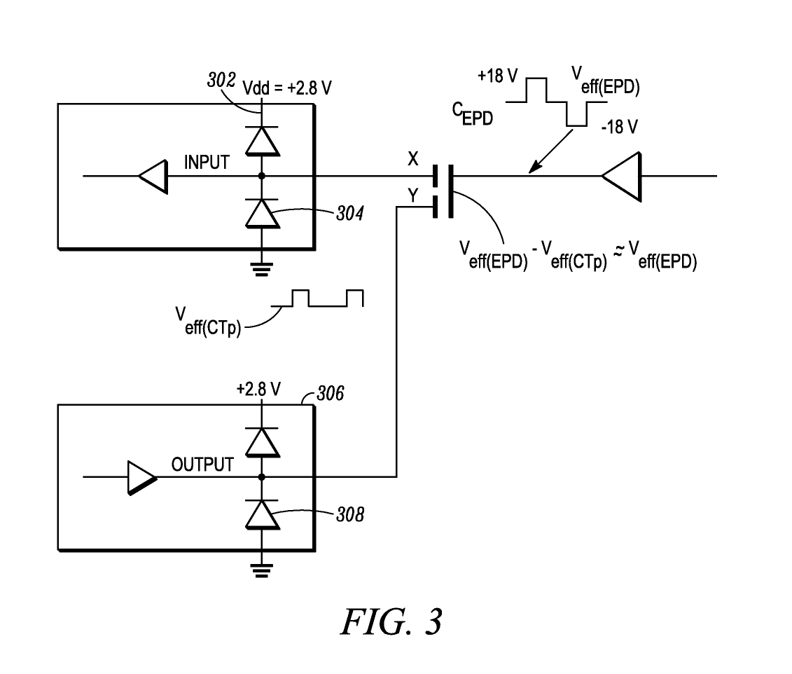

FIG. 3 illustrates an exemplary arrangement of a capacitive sensing circuit diagram that will yield an effective voltage of the EPD, V_{eff(EPD)} between +18V and −18V. One way to express the algorithmic relationship of the components in FIG. 3 is [V_{eff} (EPD)−V_{eff}(CTp)]˜˜V_{eff} (EPD); where V_{eff} (CTp) is a constant pulse train.

For sensor electrode Y, the upper diode 302 has to withstand (18V−V_{dd}), where V_{dd} is typically +2.8V. Lower diode 304 connected to ground has to withstand 18V, upon transmission of an input signal. For sensor electrode X, the upper diode 306 has to withstand (18V−V_{dd}), where V_{dd} is typically +2.8V. Lower diode 308 connected to ground has to withstand 18V upon receipt of an output signal.

Notably, the EPD may still switch with the presence of a capacitive sensing voltage. Additionally, high voltage diodes are useful for internal circuit protection.

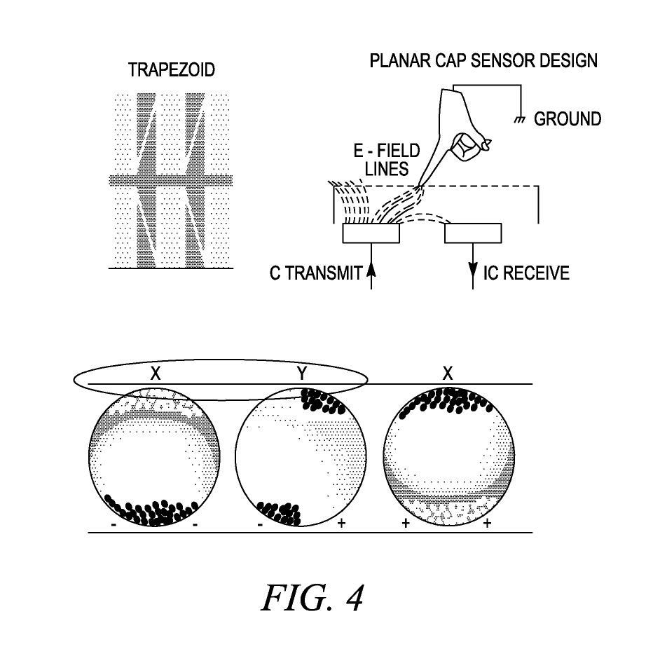

When a top plane electrode is used as planar capacitive sensor pattern, as shown in FIG. 4, there is a modification of the top plane Vcom electrode in an EPD and it is used simultaneously as a capacitive sensing electrode. The top plane layer Vcom, typically indium tin oxide, ITO, can be patterned into a one layer capacitive touch design such as trapezoid, snowflake, or diamond pattern.

Since the average capacitive sensing of V_{dd}*T_{b} or V_{cs}*T_{f}/10 is typically less than or approximately equal to 0.12Vs over a cycle time of the capacitive sensing driving scheme, which is much less than V_{eff}*Tₚ; about 1.5Vs is needed to generate a noticeable optical response for EPD pixels, using the exemplary patterned top plane electrodes (Vcom) described above (e.g., trapezoid, snowflake, or diamond) as a capacitive sensing panel will not negatively impact EPD operation. In addition, the coupling from the EPD driving waveform of the bottom electrode is too low in frequency (that is it is less than 10 Hz), it is nearly DC current to the capacitive sensing circuitry and can be easily filtered out without affecting the capacitive sensor signal-to-noise ratio. A preferable signal-to-noise ratio is 2:1.

This particular embodiment eliminates the additional capacitive sensor layers of conventional TTP design, and completely solves the optical loss issue normally associated with traditional touch panels for EPDs.

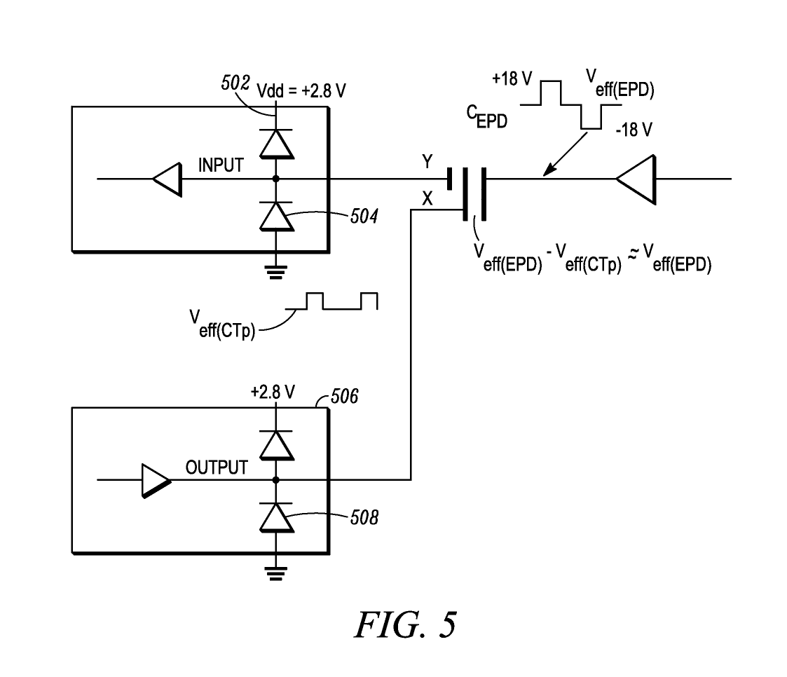

Another embodiment of the present invention is shown in FIG. 5 utilizing a second type of capacitive sensing circuit diagram. The algorithmic relationship of the components in FIG. 5 is expressed as: [V_{eff}(EPD)−V_{eff}(CTp)]˜˜V_{eff} (EPD); where V_{eff} (CTp) is a constant pulse train. The circuit in FIG. 5 yields an effective voltage of the EPD, V_{eff(EPD)} between +18V and −18V.

For sensor electrode Y, the upper diode 502 has to withstand (18V−V_{dd}), where V_{dd} is typically +2.8V. Lower diode 504 connected to ground has to withstand 18V, upon transmission of an input signal. For sensor electrode X, the upper diode 506 has to withstand (18V−V_{dd}), where V_{dd} is typically +2.8V. Lower diode 508 connected to ground has to withstand 18V upon receipt of an output signal.

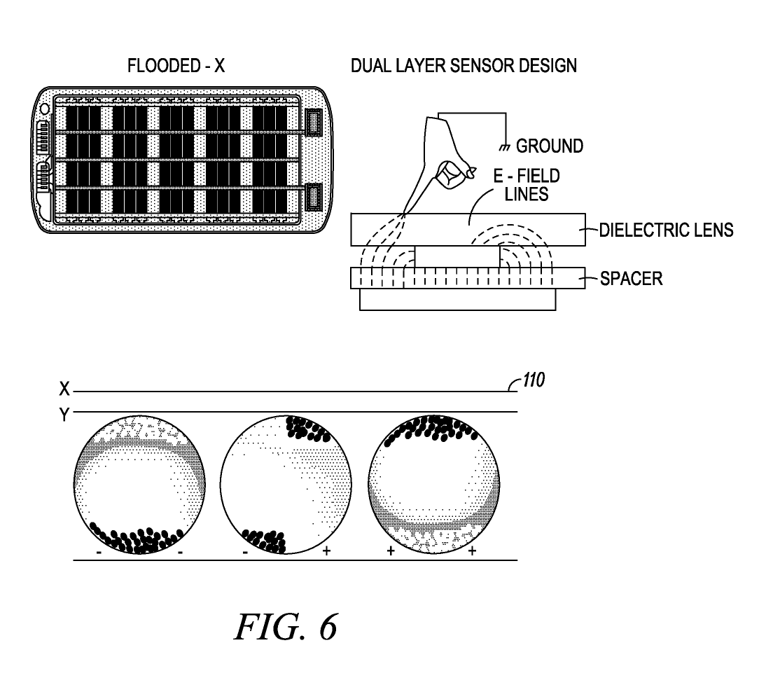

In the circuit shown in FIG. 5 and the illustrative schematic shown in FIG. 6, the top plane electrode is used as part of a dual layer capacitive sensor pattern. That is, one can use the top plane electrode of an EPD as the X sensor electrode for a dual layer capacitive sensor pattern, such as the flooded-X pattern shown in FIG. 6.

The large X-sensor pattern on a flooded-X design cover the top plane with each segment much greater than a conventional EPD pixel; therefore, making it very effective as the common electrode for the EPD driving circuit. However, thin perpendicular ITO stripes are used on top of the top plane to form the Y sensor of a dual layer capacitive sensor design.

Since the Y-sensor electrode occupies only a very small fraction of the display surface, it only has a minimal optical impact on the overall transmittance of the EPD device. Furthermore, one can also design a pattern such that the Y electrodes align with the pixel gaps in the EPD to eliminate the optical loss impact.

Similar to the planar sensor design shown in FIG. 4, the driving waveform difference between the EPD and capacitive sensor enables a designer to affix both the EPD and the capacitive sensor on the same electrode set without compromising either the EPD or capacitive sensor operation.

The embodiment shown in FIGS. 5 & 6 has an added benefit over the planar version shown in FIGS. 3 & 4 in that the X-sensor, as shown in FIGS. 5 & 6, acts as a shield to the Y-sensor, which improves the capacitive sensing signal-to-noise ratio, (SNR). A preferable SNR can be 2:1. In the embodiment shown in FIGS. 5 & 6, all the X-sensors have the same capacitive sensing charging waveform, which provide the added capability to add an offset voltage same as the capacitive sensor charge voltage to the EPD bottom electrode to further minimize any cumulative effect of the capacitive sensor to the EPD optical response.

Moreover, the embodiment shown in FIGS. 5 & 6 also eliminates the additional capacitive sensor layers of a conventional TTP design. Thus, the problem of optical loss associated with traditional touch panel for an EPD is solved with this embodiment as well.

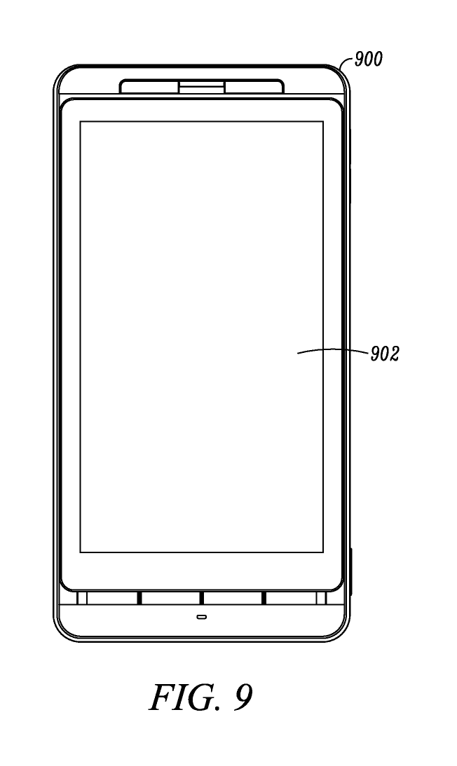

A front view of a mobile device 900 is shown in FIG. 9. Mobile device 900 includes an integrated touch panel 902, wherein the integrated touch panel 902 comprises a capacitive touch sensor and an EPD.

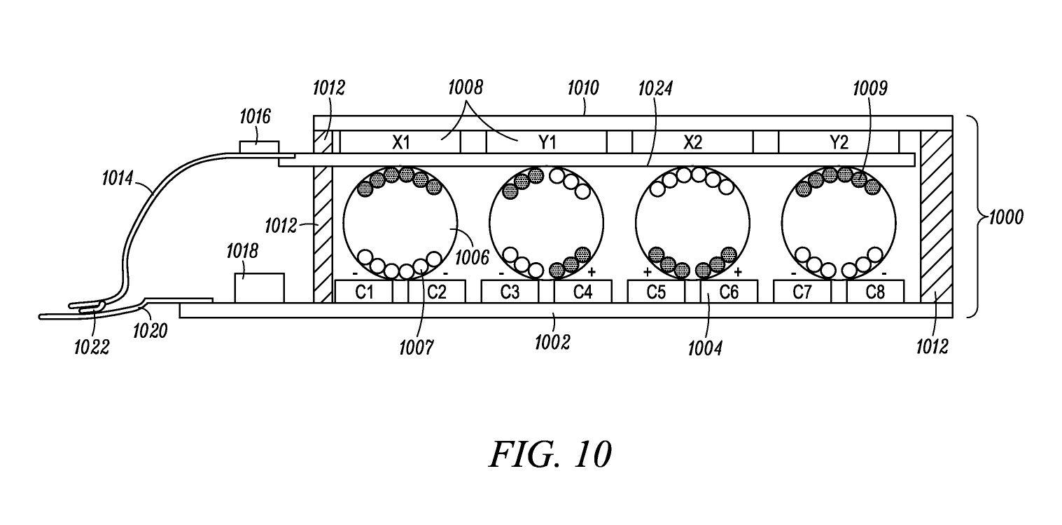

An exemplary display assembly of an integrated touch panel with EPD 1000, for an electronic device, is shown in a side view in FIG. 10. A plurality of EPD capsules 1006 resides between display electrodes 1004, found on display substrate 1002, and touch sensor/electrodes 1008 that reside on transparent conductive substrate 1124. An electrode configuration that includes pairs of sensors, (X and Y) form or embody an integrated touch panel having a capacitive touch sensor with an EPD. A protection sheet 1010 may lie above the touch sensor/electrodes 1008. A seal 1012 prevents debris from entering the integrated touch panel 1000.

The integrated touch panel 1000 further includes a TTP integrated chip 1016, as a touch controller, connected electrically via touch controller flex strip 1014 to the shared electrode for the capacitive touch sensor and EPD, touch sensor/electrode 1008. A display flex strip 1020 connects electrically to an EPD integrated chip 1018 for driving the display. Display flex strip 1020 and touch controller flex strip 1014 may be bonded together via a soldered joint 1022 oranisotropic conductive film (ACF) as an alternative to using solder. Alternatively, connectors that are soldered or are part of a zero insertion force connector or socket (ZIF) may be used.

FIG. 10 illustrates that colored pixels 1007 and 1009 may be used. For example, pixels 1007 may be red, while pixels 1009 may be black. Accordingly, the colored pixels form colored EPD capsules for displaying a colored or non-monochrome image, i.e., an image beyond black and white or gray in tone, like sepia.

As used herein, a colored or non-monochrome image may have varying combinations of colored pixels, including red, green, blue, yellow, black, magenta, white, and cyan, for example. In addition, a colored image may result from application of a color filter in combination with the EDP display.

The electrode configuration of FIG. 10 is akin to the patterned structure seen in FIG. 4. Several different patterns may be employed including trapezoid, snowflake, and diamond, for example. The integrated touch panel circuitry may reside in a grid matrix formed from resistors and capacitors.

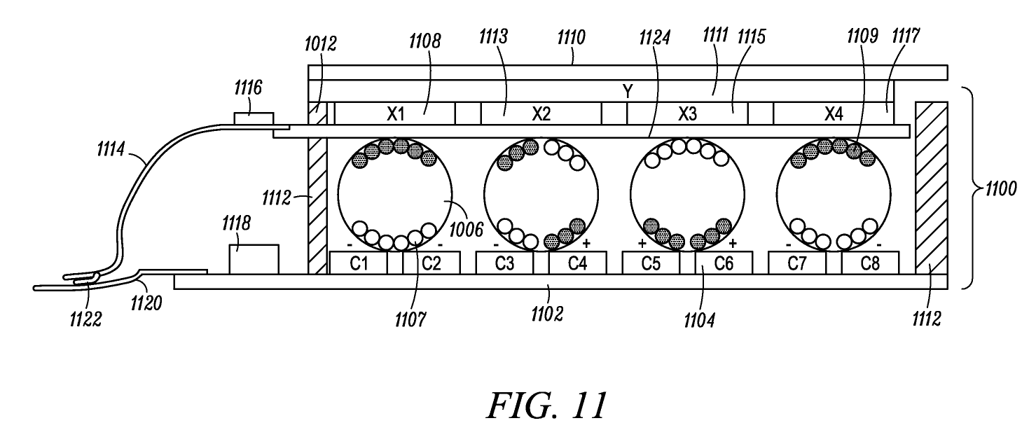

Another exemplary display assembly is shown in a side view in FIG. 11. A plurality of EPD capsules 1106 resides between display electrodes 1104, found on display substrate 1102, and touch sensor/electrodes 1108, 1113, 1115, 1117 that reside on transparent conductive substrate 1124. An electrode configuration may include a large X-sensor pattern on a top plane as a common electrode for the EPD driving circuit. In contrast, the Y-sensor occupies a very small fraction of the display surface, thus having minimal impact on the overall optical transmittance of the electronic device. A protection sheet 1110 may lie above the touch sensor/electrode 1111. A seal 1112 prevents debris from entering the integrated touch panel 1100.

The integrated touch panel 1100 further includes a TTP integrated chip 1116, as a touch controller, connected electrically via touch controller flex strip 1114 to the shared electrode for the capacitive touch sensor and EPD, touch sensor/electrode 1108. Touch sensor/electrode 1108 may be a front drive electrode or a top drive electrode. A display flex strip 1120 connects electrically to an EPD integrated chip 1118 for driving the display. Display flex strip 1120 and touch controller flex strip 1114 may be bonded together via a soldered joint 1122 or anisotropic conductive film (ACF) as an alternative to solder. Alternatively, connectors that are soldered or are part of a zero insertion force connector or socket (ZIF) may be used.

FIG. 11 illustrates that colored pixels 1107 and 1109 may be used. For example, pixels 1107 may be red, while pixels 1109 may be black. Accordingly, the colored pixels within a dispersion medium form colored EPD capsules for displaying a colored or non-monochrome image, i.e., an image beyond black and white or gray in tone, like sepia. The dispersion medium may include a hydrocarbon oil having surfactants and charging agents that cause particles (e.g., titanium dioxide particles) to accept an electrical charge.

An EPD capsule as used herein may include a structure having one or more different particles within the structure that can either absorb or reflect light upon receipt of an electrical charge. The structure may be circular or another suitable shape.

The electrode configuration of FIG. 11 is akin to the flooded-X structure seen in FIG. 6. The integrated touch panel circuitry may reside in a grid matrix formed from resistors and capacitors.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more, unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, floating point processors, customized processors and field programmable gate arrays (FPGAs) and unique stored program instructions, methods, or algorithms (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A display assembly, comprising:
a touch sensor including at least one first electrode and at least one second electrode; and
an electrophoretic display (EPD), the EPD including the at least one first electrode as a drive electrode.

2. The display assembly as claimed in claim 1, further including a plurality of first electrodes, wherein the plurality of first electrodes are respective touch sensor electrodes.

3. The display assembly as claimed in claim 1, wherein the at least one first electrode is carried on one side of the EPD and the at least one second electrode is positioned adjacent a second side of the EPD.

4. The display assembly as claimed in claim 2, further comprising a controller circuit, the controller circuit connected to the touch sensor electrodes.

5. The display assembly as claimed in claim 4, wherein the controller circuit is connected to the touch sensor electrodes and to at least one second sensor, the controller circuit operable to detect a change in the capacitance cooperatively with a user's touch.

6. The display assembly as claimed in claim 1, wherein the at least one first electrode includes at least one front drive electrode of the electrophoretic display.

7. The display assembly as claimed in claim 6, wherein the at least one front drive electrode includes a plurality of partitioned capacitive electrodes.

8. The display assembly as claimed in claim 6, wherein the at least one front drive electrode for the EPD functions as a transmitter for the touch sensor.

9. The display assembly as claimed in claim 6, wherein at least one front drive electrode for the EPD functions as a receiver for the touch sensor.

10. The display assembly as claimed in claim 1, further including a transparent layer, the at least one first electrode carried on the transparent layer.

11. The display assembly as claimed in claim 7, wherein the partitioned capacitive electrodes of the front drive electrode are all driven by a single charging waveform.

12. The display assembly as claimed in claim 1, further including a display driver, the controller circuit connected to a display driver for the EPD.

13. The display assembly as claimed in claim 12, further including a flex strip, the flex strip electrically connecting the touch sensor to the display driver.

14. The display assembly as claimed in claim 1, further comprising EPD capsules.

15. A method for integrating capacitive touch capability with an electrophoretic display (EPD), comprising the steps of:
a. employing at least one electrode of the EPD as the EPD's driving electrode and also as a capacitive touch sensor electrode.

16. The method claimed in claim 15, further comprising the step of:
b. providing a transparent conductive layer beneath the electrode employed as the driving electrode for the EPD and also as the electrode for the capacitive touch sensor.

17. The method claimed in claim 16, wherein the transparent conductive layer is patterned so that the transparent conductive layer functions as also a capacitive sensing electrode.

18. The method claimed in claim 16, wherein a biased direct current is applied to the transparent conductive layer so that signal to noise ratio of the combined EPD and capacitive touch sensor is improved over the signal to noise ratio of a stand-alone capacitive touch sensor.

19. The method claimed in claim 16, wherein a biased alternating current is applied to the transparent conductive layer so that signal to noise ratio of the combined EPD and capacitive touch sensor is improved over the signal to noise ratio of a stand-alone capacitive touch sensor.

20. An electronic device, comprising:
a. a patterned top plane electrode disposed as a planar capacitive sensor electrode;
b. a bottom plane electrode disposed as a planar capacitive sensor electrode;
c. an electro-optical layer between the top and bottom plane electrodes, and comprising a dispersion medium and electrophoretic particles both of which are influenced by an electrostatic field, wherein the electrophoretic particles are enabled to migrate within the dispersion medium; and
d. a controller circuit operable to generate driving signals applied to the top plane electrode for touch sensing and driving the electro-optical layer.

21. The electronic device as defined in claim 20, wherein the top plane electrode is aligned with pixel gaps in the EPD.

22. The electronic device as defined in claim 20, further including a transceiver, the controller circuit coupled to the transceiver, the controller circuit also controlling image generation on a display and responsive to a user's touch contacts upon a touch sensor.
